(19) United States
(12) Patent Application Publication
(10) Pub. No.: US 2011/0022635 A1
(43) Pub. Date: Jan. 27, 2011

(54) Method and System to Formulate Queries With Minivisuals

(76) Inventors: Moris Michael, Ashdod (IL); Ronen Shilo, Gedera (IL)

Correspondence Address: HENRY BRENDZEL, 5 Gilbert Place, Millburn, NJ, 07041, US

(21) Appl. No.: 12/509,468

(22) Filed: Jul. 26, 2009

(51) Int. Cl. G06F 17/30

(52) U.S. Cl. 707/780; 707/E17.062; 707/E17.108

(57) ABSTRACT

Helpful query suggestions are obtained by displaying a minivisual with each query suggestion that is developed from a submitted partial query.

### FIELD OF THE INVENTION

This invention relates generally to a method and system for assisting users by associating strings with images, such as assisting users to formulate search queries to be applied to a search engine.

### BACKGROUND OF THE INVENTION

Search engines provide a powerful means for locating and retrieving documents in network computers, accessible via the Internet or an intra-net, and even in a non-networked computer.

A search engine query is created by the user entering a string consisting of one or more search terms into a textbox, and when the user signals that the query is complete (e.g., by pressing the “Enter” key), the contents of the textbox are sent to a predetermined search engine. The search engine performs a search based on the query that the user provided, and returns to the user a webpage that contains a listing of items that are responsive to the query. An item in the list usually comprises descriptive text and a link to a webpage that contains additional responsive material. The textbox into which the user enters the query is typically either in a webpage that a browser displays, or in a toolbar. For sake of clarity, the disclosure below assumes that the textbox is in a webpage that is displayed by a browser.

Until recently, a query has been sent to the search engine only after the user has signaled that the query is complete. However, in U.S. Pat. No. 7,487,145, issued Feb. 3, 2009, Gibbs et al describe a system and method where the user's browser is enhanced with the capability to send the contents of the browser's search textbox in the search engine whenever the browser determines that the user has finished entering a portion of the search, such as when a space character is typed the search engine returns query candidates. The query candidates are created by the search engine appending different character strings to the tail end of the received string, based on searched that the search engine handled in the past, to thereby form a set of query candidates. This process is sometimes referred to as auto-completion. The search engine then sends the set of query candidates to the browser, which inserts the query candidates in a drop-down menu, and displays them to the user. The user can either choose one of query candidates, or continue entering what the user has in mind. Eventually, the user signals that the query is complete, and the process of searching for responsive documents continues as before.

Currently, a number of search engines provide a textbox with functionality that is one step advanced from that which is described in U.S. Pat. No. 7,487,145; to wit, the contents of the search textbox are sent to the search engine following every key stroke rather than after completion of some portion.

Enhanced interaction can be offered to users by responding to partial queries with minivisuals rather than auto-completed strings, or with minivisuals accompanying the auto-completed strings. The same benefit accrues with query prediction algorithms that are more sophisticated than auto-completion.

### SUMMARY

An advance in the art is achieved by accepting partial queries, obtaining a set of predictions of the completed queries, obtaining from an information store, e.g. a database, a minivisual package corresponding to each of the predicted queries, and presenting to the user the predicted queries via the set of minivisuals, or the set of minivisuals together with the corresponding predicted query texts. In an enhanced embodiment, when no corresponding minivisuals are found in the storage for a particular predicted query, the user is given an opportunity to provide a file with information that depicts a minivisual and, if necessary, that file is converted to a minivisual and stored for future use. Illustratively, a URL that points to the information store of the minivisuals is under control of a party that is different from that of the search engine, and that allows all search engine enterprises to gain the benefit of this invention in a uniform manner.

### BRIEF DESCRIPTION OF THE DRAWING

FIG. 1 presents a flow diagram of a method where predicted queries are supplemented with respective minivisuals that are presented to the user;

FIG. 2 illustrates one form of presenting predicted queries;

FIG. 3 illustrates another form of presenting predicted queries;

FIG. 4 is a flow diagram of the FIG. 1 method that is augmented with a process for populating a database with minivisuals,

FIG. 5 depicts predicted queries where one of the predicted queries invites the user to provide a minivisual to the database;

FIG. 6 presents a flow diagram of the FIG. 4 method where the minivisuals are managed, and provided to search engine enterprises by a third party;

FIG. 7 presents a flow diagram of a method where predicted queries are obtained from the user's own history of past queries;

FIG. 8 illustrates presented queries in a method that combines the principles disclosed in FIGS. 6 and 7; and

FIG. 9 presents a block diagram of a system in accord with the principles disclosed herein.

### DETAILED DESCRIPTION

FIG. 1 is a flow diagram of one embodiment of a method in accord with the principles disclosed herein, which is executed in part by an application on a user's computer, and in part by a search engine. Illustratively, the application in the user's computer is a browser that operates, at least in part, according to functionalities that are embedded in the displayed web page supplied by the site addressed by the browser and displayed by the browser.

Step 10 detects a user's signal. When the detected signal is a keystroke that enters a character into the search textbox of the user's browser, or an action such as “paste” that enters a group of characters, control passes to step 12, which sends the contents of the search textbox to the search engine via, for example, the Internet.

It should be noted that the principles of this disclosure apply to any electronic search for data; and that includes different types of data, and indifferent storage locations. The latter includes, for example, data repositories on an intranet to which the user is connected, data repositories accessible via cable or fiber from remote repository, etc.

At step 20 the search engine executes a prediction algorithm keyed to the received partial search string, and thereby obtains a number of search strings (i.e., a set of n strings with n being a non-negative integer) which are the queries that the search engine enterprise predicts to be that which the user might ultimately Avant; that is, the algorithm generates a set of query candidates. The algorithm employed might be the same as the one described U.S. Pat. No. 7,487,145 or it might be different. It might be any auto-completion algorithm, or a more complex prediction algorithm, such as one that recognizes word transpositions (e.g., “diapers baby” is synonymous with “baby diapers”), or one that prepends a string of characters to the received partial search string.

In accord with the principles disclosed herein the predictions algorithm may employ for its data source the past searches executed by users generally, the past searches executed by a community of users to which the FIG. 1 user is believed to belong, the past searches executed by user himself or some combination of the above; illustratively, according to a choice made by the user.

To give an example of predictions that might differ based on the community of users to which the FIG. 1 user belongs, a partial search of “football Manchester” for users in England might lead to “football Manchester United tickets” being one of the predictions, whereas for users in the state of New Hampshire it might lead to “football Manchester Central high school” being one of the predictions.

From step 20 the method continues to step 22 where a data package is assembled for each predicted query. A data package comprises information that defines a minivisual (such an icon, a thumbnail image, animation, or a short video and the like), associated information, and the paired-up predicted query. At least some of the information for the minivisual is obtained from a database that associates minivisuals with queries. When no minivisual information is available (such as when the query has not been considered before, or when the query does not lend itself to be represented by a minivisual) the data package consists of the predicted query only.

The method continues to step 24 where the set of data packages created by step 22 is sent to the user. In step 26 the user's browser accepts the received set and displays it to the user, for example, in a drop-down menu. At this point, the process effectively stops until the user again signals the browser, which triggers step 10.

When the user signals the browser that the user has completed the query, for example, by striking the “Enter” key, control passes to from step 10 to step 41, which sends the query to the search engine to perform the desired search. Step 42 at the search engine retrieves data that is responsive to the received query and sends that data to the user's browser. Step 43 at the user's browser displays that data.

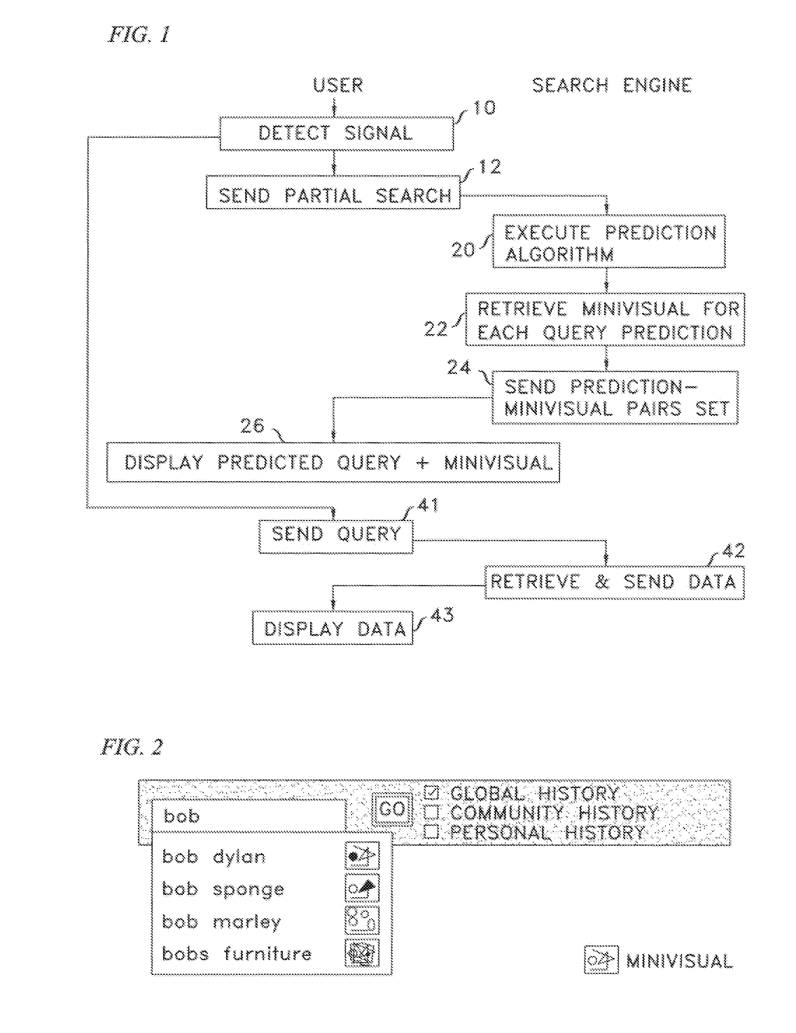

With reference to FIG. 2, illustratively following the user entering the second “b” in the search textbox (thereby forming the word “bob”), the set of predicted queries that step 26 displays is shown as a drop-down menu of the search textbox.

In accord with the principles disclosed herein, next to each of the predicted queries there is shown an associated minivisual; each intended to be recognized by users as representing the associated text. For example, the minivisuals for Bob Dylan and Bob Marley may be photographs of Bob Dylan and Bob Marley, respectively, the minivisual for “bob sponge” may be an animation of Sponge Bob, and the minivisual for “bobs furniture” may be the trademark, or logo, of Bob's Furniture. It may be noted that the FIG. 2 display also shows the choice that is offered to the user regarding whether predictions of the query should be based on the history of queries performed generally (global history), or performed based on some other corpus of past searches (i.e., community history, or personal history).

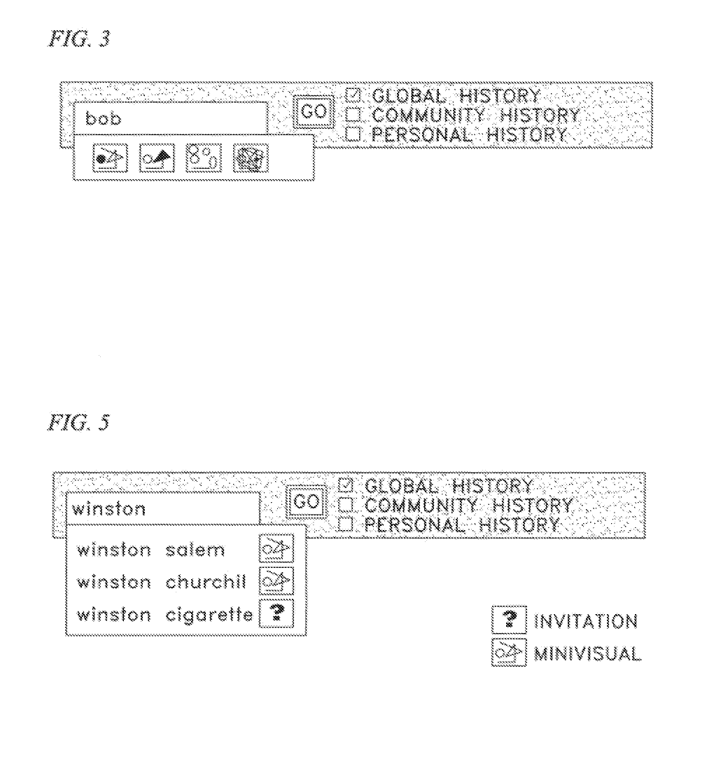

FIG. 3 depicts a different way to present the minivisuals; that is, without explicitly including the predicted query text. This saves space on the user's computer screen which, in turn, allows more choices to be presented to the user without unduly obscuring the rest of the browser's window. The text associated with each of the minivisuals may be made visible to the user, if desired, by merely pointing to a particular minivisual. The latter capability is quite conventional.

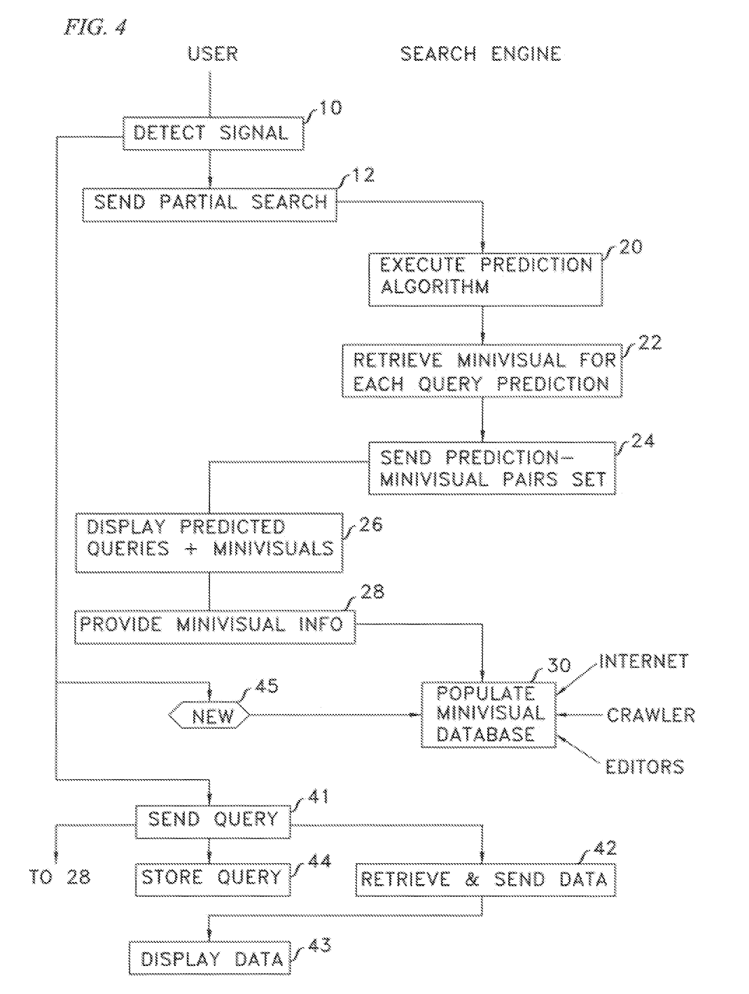

As indicated above, information about the minivisuals is obtained by accessing a database, but relative to a particular predicted query the database might not contain a corresponding minivisual (and the minivisual package consists of only the predicted query text). An improved arrangement that accommodates this situation in a beneficial manner is shown in FIG. 4, which differs from the FIG. 1 method as explained below.

In the FIG. 4 arrangement, step 22 undertakes to access the database in order to obtain a minivisual for a predicted query, and when it succeeds, it forms a package, as disclosed above. When a minivisual is not obtained, in accord with this embodiment step 22 appends information to the predicted query that invites the user to provide a minivisual. Illustratively, this invitation appears as an icon, as depicted in FIG. 5 by the question-mark icon to the right of the “Winston cigarette” text. Approaches other than an icon are also possible, such as displaying a portion of the predicted text in a different color.

When the user clicks on this icon, a process that illustratively resides in the search engine is executed at step 28 that enables the user to upload a minivisual (e.g. image, animation, movie, icon, etc.) file to the search engine. In one embodiment the user is enabled to upload any file from a selected set of file types, and it is left for the search engine to convert it so that it has the proper characteristics for serving as a minivisual (e.g., the right number of pixels and the right aspect ratio). In another embodiment, the process assists the user to create a selected type of minivisual with the proper characteristics. As part of the process of providing the minivisual to the search engine, step 28 also updates the minivisual displayed on the user's computer.

It is quite possible that users might decline the offers presented by step 28. In such a case, the process stops pending the next signal from the user.

As an incentive for users to supply minivisuals, the step 28 process allows a user to append a name (or the like) to the supplied minivisual to garner credit for it. Other users that later see the minivisual can see the credit in a tooltip, for instance, when hovering over the minivisual with the mouse-controlled pointer.

Once a minivisual is supplied, step 30 stores the minivisual in the search engine's minivisual database, in association with the query, and the process stops pending the next signal from the user.

For caution sake, provided minivisuals are reviewed by editors before they are installed in the database.

When a user finally selects a query to be searched, that query may or may not have an associated minivisual. Accordingly, step 10 moves the process to steps 45 and 41, which may be carried out essentially in parallel. Step 45 determines whether the selected query to be searched has an associated minivisual, and if not, it treats a query as one that is new to the search engine by forwarding it to step 30. Step 30 stores the received query in its database, unless it is already there, with the hope that a minivisual may be supplied later.

From the above it is seen that the minivisuals database contains queries without a corresponding minivisual when a user selects and applies to the database a query that is either totally new, or one that is already in the database but for whatever reason has not been provided with an associated minivisual. It is noted that there may be other avenues by which queries without associated minivisuals are stored in the search engine's database; such as in embodiments where members of the general public are permitted to access step 30 via the Internet and to upload queries, with or without associated minivisuals.

To find appropriate minivisuals for queries that were stored in the database without associated minivisuals, a “web crawler” program is advantageously employed in association with step 30, which actively and automatically searches the Internet (in non-real time) to find minivisuals for received entries (queries and partial queries) that do not have associated minivisuals. The editors can also create minivisuals and insert them in the database.

Step 41 performs three actions. The first action sends the query to the search engine. Responsive data is returned to the user by step 42, and step 43 displays the data on the user's browser. The second action sends the query to step 44, which stores the query in the personal history database within the user's computer, if it is not already there. The third action returns the process to step 28, if necessary to associate a minivisual with the stored query.

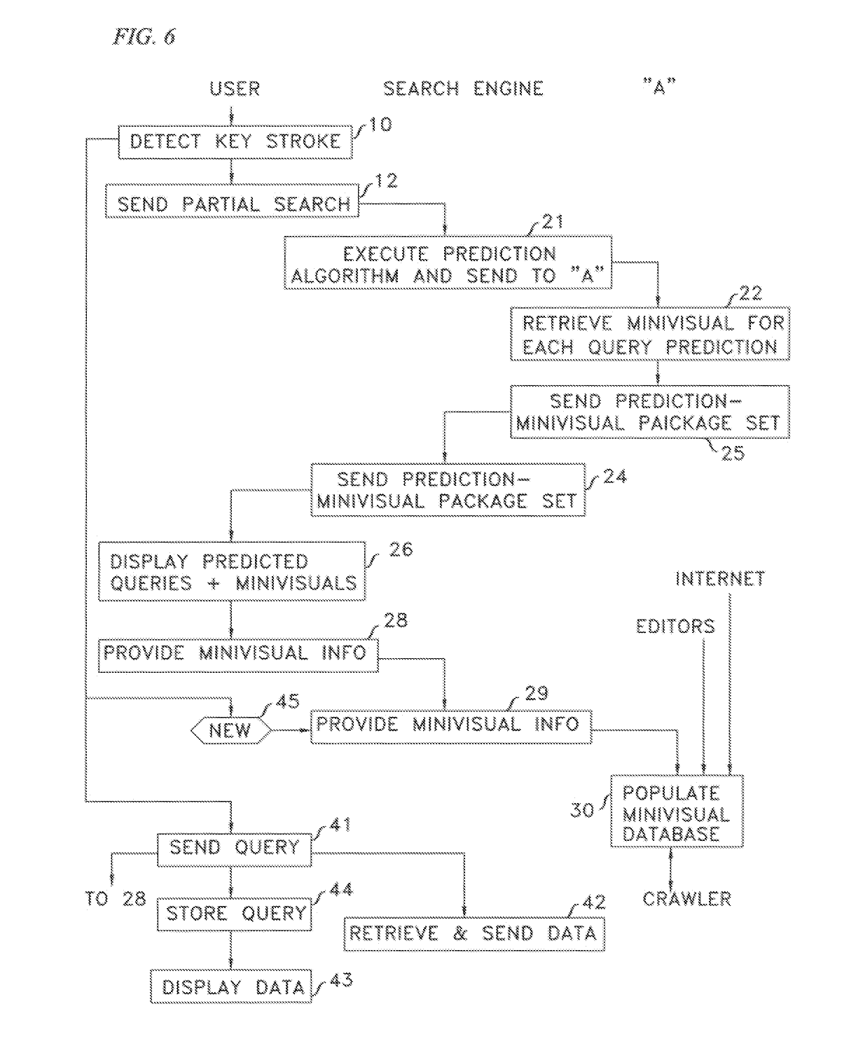

FIG. 6 presents an approach that, in a global sense, is more efficient than the FIG. 4 approach, in that the task of associating predicted queries with minivisuals is assigned to a system “A” which (a) is distinct from the search engine system, is (b) accessible via the Internet, and (c) provides data to more than just one search engine system. This enables sharing of minivisuals between users of different search engines, as well with as other entities that may request minivisuals. The FIG. 6 approach differs from the FIG. 4 approach in that step 20 is replaced with step 21, which executes a prediction algorithm as in step 20 but sends the set of predicted queries to system “A”. Within system “A”, each of the received predicted queries is applied by step 22 to a database in order to retrieve a minivisual. The resulting set of prediction queries and corresponding minivisual packages is sent by step 25 to the search engine, whereupon step 24 is executed as disclosed above. The FIG. 6 approach also differs from the FIG. 4 approach in that the information provided by step 28 is forwarded by step 29 of the search engine to system “A”, where step 30 is executed.

As suggested by the option checkboxes shown in FIGS. 2, 3, and 5, the predictions that are made may be based on past searches made by all, past searches made by persons who are in the same community of interest as the user, or on the personal history of the user. The above discussion impliedly addressed itself to past searches made by all, but the disclosed processes are effectively the same when the user chooses to have predictions be based on the “community.” The only difference lies in the database that the search engine used in constructing the predicted queries set.

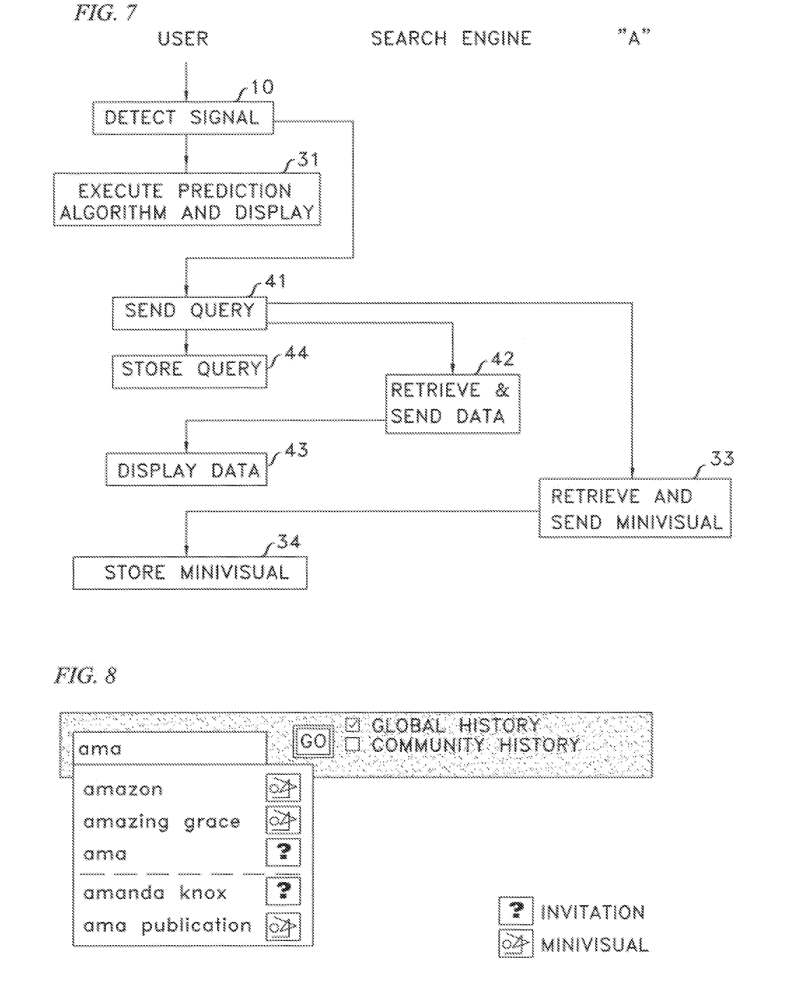

FIG. 7 depicts the method employed when the user chooses the predicted queries to be based on the personal history; i.e., have the corpus of past queries of the user himself/herself be the exclusive source from which query predictions are made. This history is most conveniently stored in the user's own computer in the form of a database.

In the FIG. 7 approach, step 10 detects when the user enters data into the browser's search textbox and applies the contents of the browser's search textbox to step 31, which executes a prediction algorithm that accesses a database within the user's computer. This algorithm can be an auto-completion algorithm, as is used in the prior art, or it can be a more sophisticated algorithm, as suggested above. The algorithm retrieves a set of predicted queries from the database, and displays the results. These results are not unlike the ones shown in FIGS. 2 and 3; that is, minivisuals are shown, if they are found within the user's computer, and the predicted text is shown as well, or can be caused to be shown upon request.

When the step 31 process completes, the method halts pending another signal from the user. Eventually, the user's signal indicates that the query is complete, and control passes from step 10 to step 41, which performs two actions. The first action sends the query to the search engine. Responsive data is returned to the user by step 42, and step 43 displays the data on the user's browser. The second action sends the query to the entity that holds a minivisuals database (in FIG. 7 that is shown to be system “A”) to obtain a minivisual to be associated with the query. If one is returned, it is stored by step 34 in the database within the user's computer, together with the query that was sent to the search engine. Otherwise, only the query is stored.

It may be mentioned that an embodiment that combines the methods of FIG. 6 and 7 i.e., where the user selects both the “global history” and the “personal history” in the FIG. 2 presentation, may be found quite attractive because it is quite easy to implement and has the advantage that a query that was previously posed by a user and is later repeated zeros in quickly on the correct predicted query. Such a method is simply a combination of the steps found in FIGS. 6 and 7 (with steps that are redundant not repeated). FIG. 8 illustrates a possible output in an embodiment where user of the personal history is always employed, so the options that are offered to the user are only “global history” and “community history.” The drop-down menu presents the predicted queries based on the personal history below the predicted queries based on the other selected corpus.

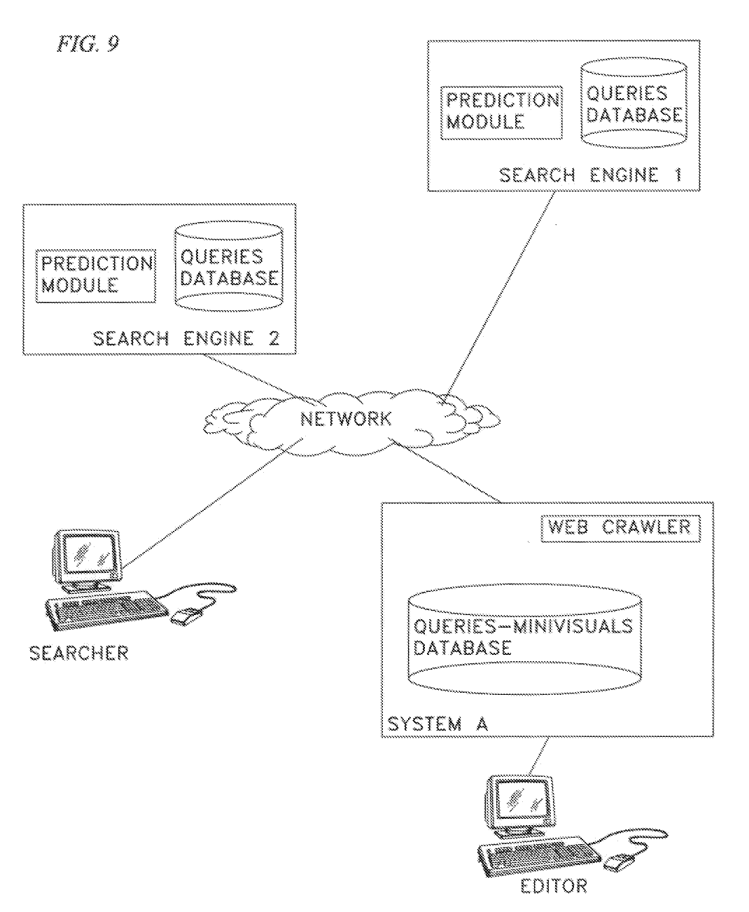

FIG. 9 depicts an arrangement that operates in accord with the method disclosed in FIG. 6. It includes a system “A” that maintains the database that associated minivisuals with queries, a plurality of search engines that are served by system “A,” and a searcher that accesses a chosen search engine and obtains the minivisuals benefits disclosed above.

The above discloses the principles of this invention by way of specific illustrative embodiments, but it should be realized that modifications and enhancements are possible without departing from the spirit and scope of this invention. For example, FIG. 6 depicts the minivisual provided by the user in step 28 being sent to the search engine, which forwards it to system “A.” This approach is necessary if the user does not have the information necessary for communicating with system “A.” When the user has the URL address of system “A” (for example, if the minivisuals that are displayed to the user include the URL address of system “A”) then step 28 might advantageously communicate with system “A” directly, obviating the need for the search engine to forward information. In a similar manner, system “A” can send the predicted query packages directly to the user, rather than via the search engine.

To give another example, the task of predicting queries can be carried out at system “A” rather than at the search engine.

To give yet another example, the minivisual can encompass text (in addition to icons, still images, and other forms, as disclosed above). This additional text advantageously is in other than the language of the search terms entered into the textbox. This may include, for example, a Chinese character, or a phrase in Hebrew, that is a translation of the predicted query.

Lastly, it should be mentioned that the principles of this invention may be applied in different contexts, such as searching for programs on a cable TV system, searching for phone numbers on telephones that have a display, search boxes that are included in applications other than a browser, etc.

1. A method for presenting data to a user comprising the steps of:
receiving a string of characters (partial query) from a device of said user;
executing a prediction algorithm on said partial query, which algorithm employs a selected corpus and which develops n character strings (query predictions) that are related to said partial query, where n is a non-negative integer;
with respect to each one of said n query predictions, accessing an information store that contains queries and associated minivisuals, aiming to identify an associated minivisual relative each of said n query predictions, respectively, and retrieving information relative to minivisuals that are respectively associated with at least some of said n query predictions; and
providing to said device a set of n packages, where each package comprises one of said n query predictions and said information relative to a minivisual associated with said one of said n query predictions, where such information was retrieved from said information store, where said device is configured to display said set of n packages.

2. The method of claim 1 where said step of receiving a partial query includes a selection of said corpus.

3. The method of claim 1 where said corpus comprises a corpus of past queries stored in said device and a corpus of past queries stored in a remote system.

4. The method of claim 1 further comprising the step of displaying said set of n packages on said device.

5. The method of claim 1 where said prediction algorithm is other than a mere auto-completion algorithm.

6. The method of claim 1 where said information relative to a minivisual enables said device to display a minivisual.

7. The method of claim 1 where said information relative to a minivisual enables said device to display a minivisual and to display information that credits a submitter of said minivisual.

8. The method of claim 1 where said steps of executing a prediction, accessing an information store, and providing said set of n query predictions is performed in a server arrangement that is coupled to said device via data network.

9. The method of claim 1 where said steps of executing a prediction, accessing said information store, and providing said set of n query predictions is performed in said device.

10. The method of claim 8 where said server arrangement is a search engine.

11. The method of claim 8 where
said server arrangement comprises a system A and a system B;
systems A and B communicate with each via said data network; and
primary mission of system A is to maintain said information store.

12. The method of claim 11 where said step of executing is executed in said system A, and said system A receives said string from said user's device directly, or via said system B.

13. The method of claim 11 where system B is a search engine, system A is accessible to a plurality of search engine, in addition to being accessible to system B.

14. The method of claim 1, further comprising a process for populating said information store, which process comprises the steps of:
receiving information that specifies a minivisual to be associated with a partial query; and
storing a data pertaining to said information in said information store.

15. The method of claim 14 where said information is received from said device.

16. The method of claim 14 where said data is a minivisual file.

17. The method of claim 16 where said information is a file.

18. The method of claim 17 further comprising the steps of:
confirming whether said file is appropriate as a minivisual file;
if said step of confirming finds that said file is appropriate, proceeding to said step of storing with said file being said minivisual file; and
if said step of confirming concludes that said file is inappropriate, modifying said file to form said minivisual file and proceeding to said step of storing.

19. The method of claim 18 where said step of confirming involves a human editor.

20. The method of claim 19 where said minivisual file is provided by a web crawler program.

21. An arrangement comprising:
a server that contains
a database that associates minivisuals with query strings, and
means for retrieving a minivisual in response to an applied query and outputting a package that includes information about the retrieved minivisual and the applied query; and
means for connecting said server to a database network.

22. The arrangement of claim 21 further comprising a search engine that sends one or more of said applied queries to said server.
